(19) United States
(12) Patent Application Publication
(10) Pub. No.: US 2017/0194714 A1
(43) Pub. Date: Jul. 6, 2017

(54) COOLED ANTENNA FEED FOR A TELESCOPE ARRAY

(71) Applicant: The SETI Institute, Mountain View, CA (US)

(72) Inventors: Matthew Christopher Fleming, Antioch, CA (US); John Christian Munson, Sunnyvale, CA (US); Jill C. Tarter, Berkeley, CA (US)

(73) Assignee: The SETI Institute, Mountain View, CA (US)

(21) Appl. No.: 15/400,661

(22) Filed: Jan. 6, 2017

Related U.S. Application Data
(60) Provisional application No. 62/275,732, filed on Jan. 6, 2016.

(51) Int. Cl. H01Q 21/00; H01Q 15/16; H01Q 1/00; H01Q 19/13

(52) U.S. Cl. CPC H01Q 21/0025; H01Q 19/132; H01Q 15/16; H01Q 1/005

(57) ABSTRACT

An offset Gregorian antenna used in radio astronomy. The antenna may include a primary reflector having a substantially paraboloidal shape and a secondary reflector having substantially an ellipsoidal shape. The secondary reflector may be displaced from the optical axis of the primary reflector. The antenna may also include a feed located substantially coincident with the second focus of the secondary reflector. The feed may be located within a vacuum sealed enclosure, and a cryo pump may be used to cool the feed within the enclosure. Also, a shroud may partially surrounding the feed.

### CROSS-REFERENCE TO RELATED APPLICATIONS

This application claims the benefit of U.S. Provisional Application No. 62/275,732, filed Jan. 6, 2016, which is herein incorporated by reference in its entirety.

### BACKGROUND

Reflector-type antennas and antenna systems based on the offset Gregorian design are known in the radio astronomy field. Single large dishes in radio astronomy are being replaced with an array of a large number of small antenna dishes with a pseudo-random arrangement. This design provides a high quality beam shape, the spot in the sky to which the telescope is most sensitive, and because of the relatively large number of antenna dishes, the array minimizes sensitivity outside the primary beam. The array of small antenna dishes may cover frequencies between 500 and 10,000 MHz.

The array of small antennas incorporates a configuration known as an offset Gregorian design may be implemented wherein a secondary reflector is positioned off the primary axis. In this design, a secondary mirror bounces incoming radio signals collected by the large primary reflector back to a feed antenna where they are amplified and sent to control stations. This structure has many benefits such as improved beam efficiency, greater effective area, and lower sidelobe levels. However, feed spillover onto the ground from this design may carry a potential for increased background noise, leading to lowered sensitivity and increased signal collection times. This is a particularly important characteristic for applications in radio astronomy in which the goal is typically to detect, collect, and analyze faint signals emanating from the sky.

The reciprocity theorem for antennas is a well-known and often-used theorem showing that the performance of an antenna is the same whether it is used in reception or transmission, provided however, that no non-reciprocal devices (such as diodes) are present. For the typical cases considered herein, the reciprocity theorem applies and we describe the performance of antennas either in transmission or reception without distinction. That is, when used for transmission, electromagnetic energy is delivered to the antenna for transmission by means of a “feed.” When used in reception, energy collected by the antenna is delivered to a “detector” for detection and delivery to various electronic or other signal processing means. In the descriptions herein, the reciprocity theorem is employed and feeds or detectors are described as components of the antenna or antenna system without distinction, unless specifically noted.

The result is added noise at the input of the LNA from the room temperature structures. Therefore, what is needs is a system and method to maintain the benefits of the offset Gregorian antenna design while reducing added noise by cooling the feed and lead inputs. Addressing this need would result in an antenna with improved performance, including improved signal collection efficiency.

### SUMMARY

Briefly, and in general terms, various embodiments are directed to an offset Gregorian antenna used in radio astronomy. The antenna may include a primary reflector having a substantially paraboloidal shape and a secondary reflector having substantially an ellipsoidal shape. The secondary reflector may be displaced from the optical axis of the primary reflector. The antenna may also include a feed located substantially coincident with the second focus of the secondary reflector. The feed may be located within a vacuum sealed enclosure, and a cryo pump may be used to cool the feed within the enclosure. Also, a shroud may partially surrounding the feed.

Other features and advantages will become apparent from the following detailed description, taken in conjunction with the accompanying drawings, which illustrate by way of example, the features of the various embodiments.

### BRIEF DESCRIPTION OF THE DRAWING

FIGS. 1A and 1B depict an exemplary embodiment of a reflector type antenna.

FIG. 2 depicts an exemplary embodiment of an antenna feed sealed within a vacuum sealed enclosure.

FIG. 3 depicts an exemplary embodiment of a low noise amplifier that is associated with the antenna feed.

FIG. 4A depicts an exemplary embodiment of a distal end of a feed surrounded by thin rexolite standoff

FIG. 4B depicts an exemplary embodiment of a circuit of the low noise amplifier of the feed.

FIG. 4C depicts an exemplary embodiment of a tip of an antenna feed that is in communication with a low noise amplifier.

FIG. 5 depicts a chart showing the noise ratio of one embodiment of an antenna feed.

FIGS. 6 and 7 depict charts showing the temperature of an antenna feed according to one embodiment.

FIG. 8 depicts an exemplary embodiment of a vibration isolation mechanism for an antenna.

### DETAILED DESCRIPTION

The detailed description is to be construed as exemplary only and does not describe every possible embodiment since describing every possible embodiment would be impractical, if not impossible. Numerous alternative embodiments could be implemented, using either current technology or technology developed after the filing date of this application.

The present disclosure relates to antennas for transmission and reception of electromagnetic radiation and, in particular, to structures for log-periodic antennas, antennas containing such structures and methods to transmit and detect electromagnetic signals with such antennas.

The feeds are room temperature dual polarization Log Periodic Antennas. Because the input terminals of the feed are at the tip of the feed for all operating frequencies, each balanced linear polarization of the received signal must pass from each signal's active region along the backbone of the warm feed to the warm tip of the feed, and then onto a microstrip and twin lead transmission inputs into a dewar containing the low noise amplifier.

An antenna is a structure (or structures) associated with the transition of electromagnetic energy from propagation in free-space to confined propagation in waveguides, wires, coaxial cables, among other devices (that is, reception), or the reverse process (transmission). The transition from free-space (or “far-field”) propagation to confined propagation is not abrupt but occurs through a “near-field” region in the vicinity of the antenna in which the electromagnetic characteristics are neither those of free-space propagation nor confined propagation. The performance of the antenna as a transmitter or receiver of electromagnetic energy depends upon many factors including the geometric and electromagnetic properties of the antenna as well as the geometric and electromagnetic properties of structures affecting the electromagnetic characteristics of the near-field region. Practical antenna designs need to take into account the effect on antenna performance of structures in the near-field region including transmission lines, electronic detectors (for reception), antenna support members or other nearby objects including, in many cases, the surface of the earth.

Many applications require the detection of very weak electromagnetic signals. In such cases, transmission losses occurring between the antenna and remote electronics can be a serious concern. Thus, antenna designs that permit the location of electronic devices in close proximity to the antenna are desirable for weak signal detection such as commonly arise in the field of radio astronomy, and for transmissions such as deep space communication, or in connection with NASA's deep space network.

The performance of many antennas typically depends markedly upon the frequency of the electromagnetic energy transmitted (or received). Such frequency-dependent behavior can be accepted when an antenna is intended to transmit or receive a single frequency or very narrow range of frequencies. However, for other applications it is advantageous that the performance of the antenna be approximately independent of frequency. One example is the search for extraterrestrial intelligence (“SETI”), which involves the scanning of relatively large portions of the electromagnetic spectrum for evidence of signals created by extraterrestrial intelligent beings.

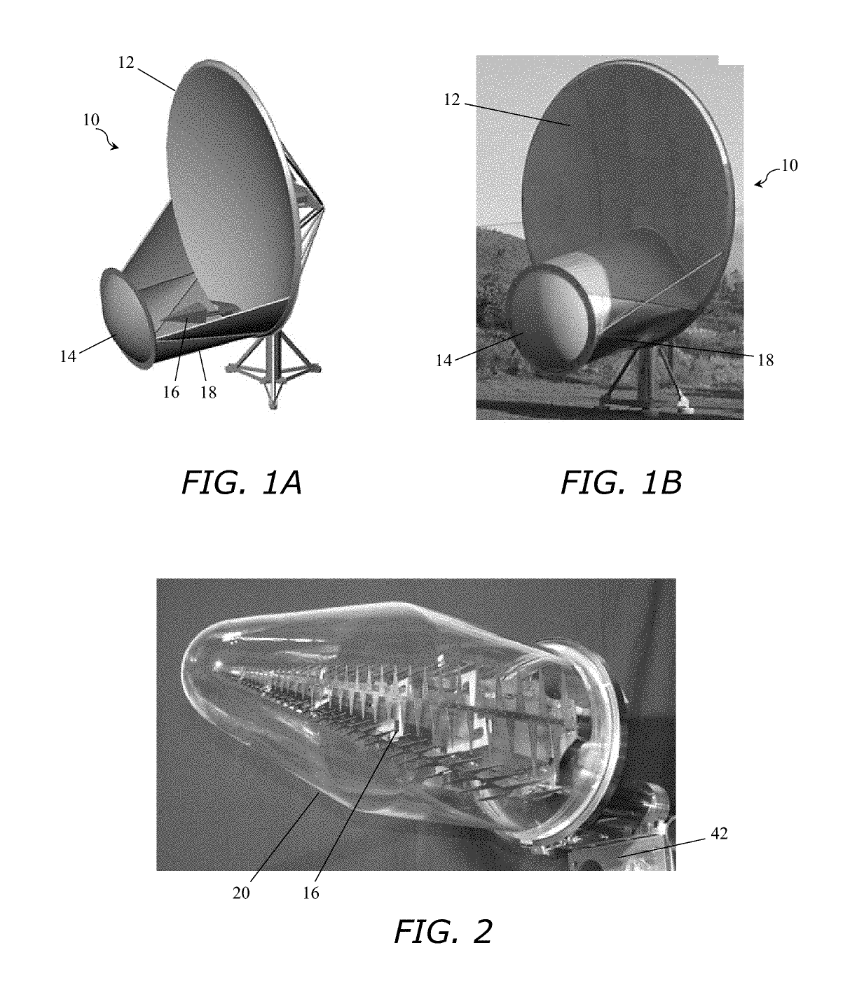

According to one embodiment, a cooled telescope array includes forty-two (42) antennas having an offset Gregorian configuration. Any number of antennas may be included in the array and it is relatively easy to scale the array up or down with small dishes. As shown in FIGS. 1A and 1B, an antenna 10 includes a large primary reflector 12 having substantially a paraboloidal shape, and a smaller secondary reflector 14 having substantially the shape of an ellipsoid. The primary reflector may have approximately a 6.1 meter diameter, although any antenna diameter may be used by one of skill in the art. The secondary reflector may be approximately 2.4 meters, but any diameter may be used. The secondary reflector 14 is placed in front of the primary reflector 12 with one of its foci substantially coincident with that of the focus of the paraboloid and the other ellipsoid focus near the vertex of the paraboloid. With this arrangement, distant rays that are substantially parallel to the optical axis strike first the primary reflector and then the secondary reflector, and are finally focused at the second focal point of the ellipsoid near the vertex. In the offset case, neither the primary nor the secondary need to be symmetric relative to the optical axis, and only the corresponding portion of the secondary needed to catch the partial primary rays can be kept. The region of the Gregorian focus may then be free of all but the rays coming to it from the secondary, and a feed or detector 16 placed at that focus will not substantially block the rays. Thus, the effective entrance window is substantially free of obstruction of the rays by either the secondary reflector or a detector located at the focus.

One embodiment of the antenna 10 includes a shroud 18. The shroud may be cylindrical and made of metal or other conducting material. The shroud 18 partially surrounds the feed 16 at the Gregorian focus as shown in FIG. 1A. The shroud 18 intercepts a very small amount of electromagnetic energy (or rays) incident on the primary along the optical axis or any of the rays reaching the feed from the secondary. The shroud 18 is typically located on the side of the optical axis toward the ground. With the antenna 10 functioning as a transmitter, radiation in the sidelobes of the feed 16 that is emitted toward the ground is reflected up toward the sky either directly or by reflection from the primary or secondary reflectors 12 or 14. This reflected radiation contributes to the overall sidelobes of the system toward the sky. With the system operating as a receiver, it now effectively receives radiation only from the sky and not from the ground. The top of the shroud 18 may he covered by a radio transparent plastic covering and may provide protection for the feed 16 from the environment. The shroud may also be covered by any material transparent to the electromagnetic radiation of interest as shown in FIG. 1B.

In one embodiment, the antenna array has approximately 1250 independent pixels with a good point spread function. The antenna array, according to one embodiment, has the following properties:
Θ(field)˜λ(m)/6 m
0.2/6˜2°
Θ(res)˜λ(m)/300 m
0.2/300˜2.4′

The present antenna feeds 16 have the following features, according to one embodiment:
Log Periodic with Center Pyramid, cooled to about 70 K.
Frequency Range 0.9 to 15 GHz
Noise temperature 25 K at 2 GHz to 70 K at 12 GHz, typical.
Power consumption 300 to 500 watts.
Weight 102 lb, 46 kg.
Environmental temperatures −20 to 30 C.
Vacuum via Pfeiffer 80 lps Turbo and Diaphragm pumps.
Cooling via Sunpower GT sterling with 15 watt capacity at 77 K.
Air circulation via Pabst centrifugal fan.
Feed control via electronics & software.
Post Amplifier Case attached.

According to one embodiment, the antenna feed 16 is sealed within a vacuum sealed enclosure 20 as shown in FIG. 2. The feed may have a length of approximately 54 cm, but may vary substantially. According to another embodiment, the tip of the vacuum sealed enclosure may include a polyethylene anti-reflective cover. In yet another embodiment, the vacuum sealed enclosure 20 may be made of a borosilicate glass that has a dielectric of 5.1. In another embodiment, fused quartz having a dielectric of 3.8 may be used for the enclosure 20. The vacuum sealed enclosure may have a thickness of approximately 1 to approximately 1.5 mm.

According to another embodiment, the vacuum sealed enclosure 20 may be made out of composite materials. The composite material allows for superior RF loss characteristics over a glass sealed enclosure. The composite vacuum sealed enclosure may also be thinner than the glass sealed enclosure (eg., 40 thousandth at the tip and 80 thousandth at the base).

According to one embodiment the vacuum sealed enclosure 20 does not utilize a cloth cover, in case of breakage. According to another embodiment, a lens is positioned inside the vacuum sealed enclosure 20.

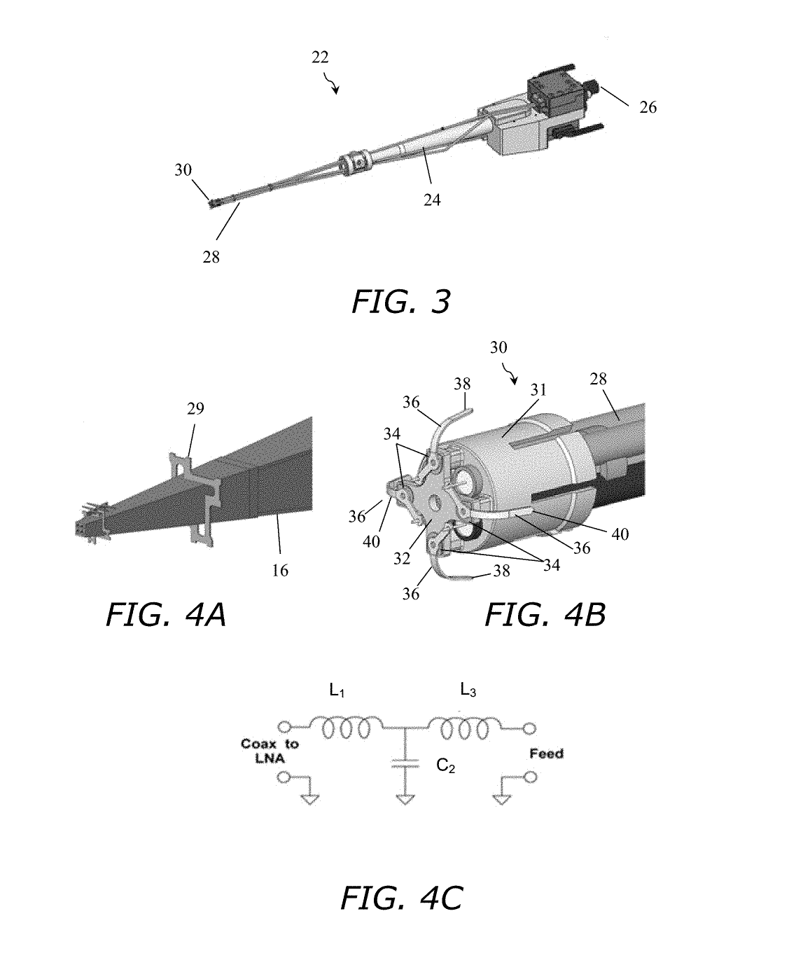

Internal to the pyramid of the antenna feed 16, a low noise amplifier (LNA) 22 may have the features shown in FIG. 3. The LNA 22 includes a chassis 24 as shown. Also, the LNA includes an output coax 26 and an input coax 28 on opposite ends of the chassis. The output coax 26 may have a resistance of about 50 ohm and a diameter of approximately 0.085 inches. The input coax 28 may have a resistance of about 95 ohm and a diameter of approximately 0.34 inches. It should be understood that the resistance and diameter of the input and output coax may vary.

According to another embodiment, the LNA 22 is positioned ahead of the feed arms to further reduce or eliminate the input coax cables. According to this embodiment, the LNA 22 is located at the tip of the pyramid of the feed 16.

The antenna feed 16 may include the details shown in FIGS. 4A-4C, according to one embodiment. As shown in FIG. 4A, the feed 16 includes a thin rexolite standoff 29. As shown in FIG. 4B, the addition of capacitance C2 on each lead L1 and L3 improves match. The low pass matching network for the feed 16 with band edge at 15 GHz is shown in FIG. 4C. In one embodiment, the approximate value of L1 and L3 is about 0.75 nH and C2 is about 0.1 pF.

FIG. 4B shows one embodiment of a tip 30 of the feed at the distal end that includes a tip coax hub 31. The hub 31 may be formed of beryllium-copper or phosphor-bronze. The tip 30 includes four input coax cables 28 that are connected to the LNA 22 at one end, and a capacitor board 32 at the other (distal) end. The input coax cables 28 are held together by the tip coax hub 31. Although four input cables are preferred, any number of input coax cables may be used. The capacitor board 32 include four 0.1 pF pads 34 that are approximately 0.010 inch thick and approximately 0.120 inch diameter. Rogers 3010 substrate pads are approximately 0.022 inch across. It should be understood that the dimensions of the capacitor board may vary. Furthermore, the tip 30 includes four flex link elements 36 that may be soldered or otherwise connected to the pads 34 the capacitor board 32. The flex link elements 36 include two X poles 38 and two Y poles 40. The flex link elements 36 connect the input coax cables 28 to the capacitor board 32. In one embodiment, the flex link elements 36 may be formed of Beryllium-Copper (Be—Cu) and have a thickness of about 0.0065 inches and about 0.008 inches wide. The dimensions and material used to form the flex link elements may differ. In one embodiment, the flex link elements 36 prevent fatigue damage due to vibration and thermal displacements.

In one embodiment, the feeds 16 are room temperature dual polarization Log Periodic Antennas with LNAs that are cooled to 70 K. Because the input terminals of the feed 16 are at the tip of the feed for all operating frequencies, each balanced linear polarization of the received signal must pass from each signal's active region along the backbone of the warm feed to the warm tip of the feed, and then onto a microstrip and twin lead transmission inputs into a cooled vacuum dewar containing the low noise amplifier. The result is added noise at the input of the LNA from the room temperature structures.

In another embodiment, the feeds 16, along with their LNAs 22 and input cables 28, are cooled to 65 K to provide a low system temperature for the antenna. In this embodiment, to enable the cooling, the feeds are contained the vacuum sealed enclosure 20, such as a Pyrex glass vacuum bottle. In turn, the sealed enclosure 20 may be capped by dielectric lenses that minimize the reflection of the incoming signals by the enclosure 20 at higher frequencies.

In one embodiment, the new Log Periodic feeds operate over the band 0.9 to 15 GHz, four octaves, for the flexibility in observation that this large bandwidth provides. Total measured system temperatures, including antenna spillover and atmospheric brightness, are 30K-40K over 0.9-10.0 GHz, rising up to 40K-60K over 10-15 GHz. This is a large improvement in the sensitivity of each antenna. The lens thickness and offset from the enclosure 20 are optimized for good wide-band transmission through the glass of the enclosure. Careful design of the cooling system to avoid destructive vibration of the system has also been essential to achieving a successful design.

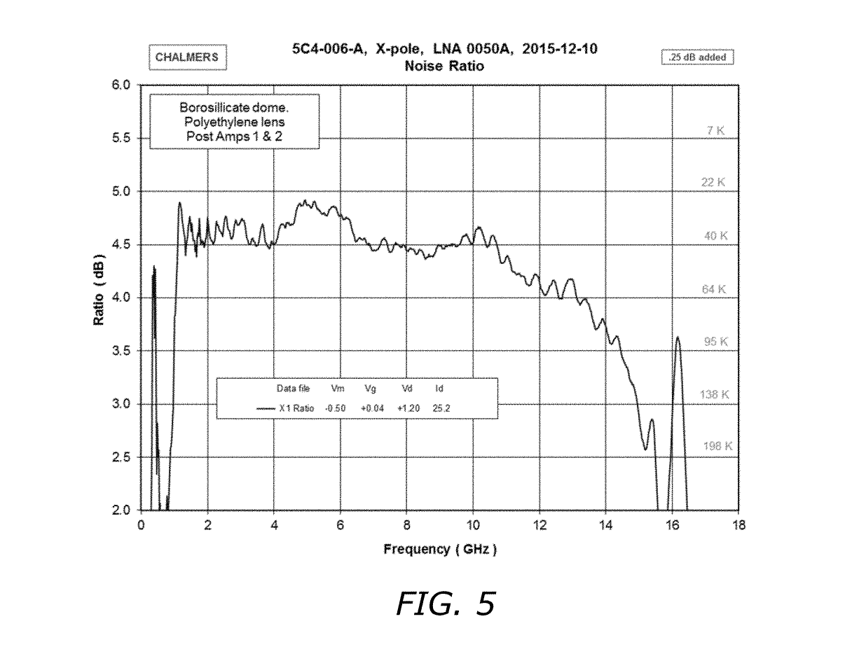

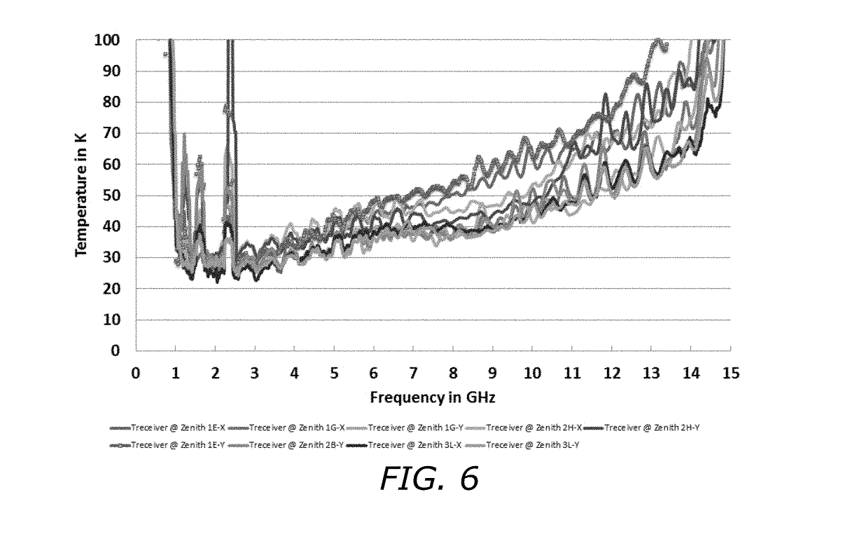

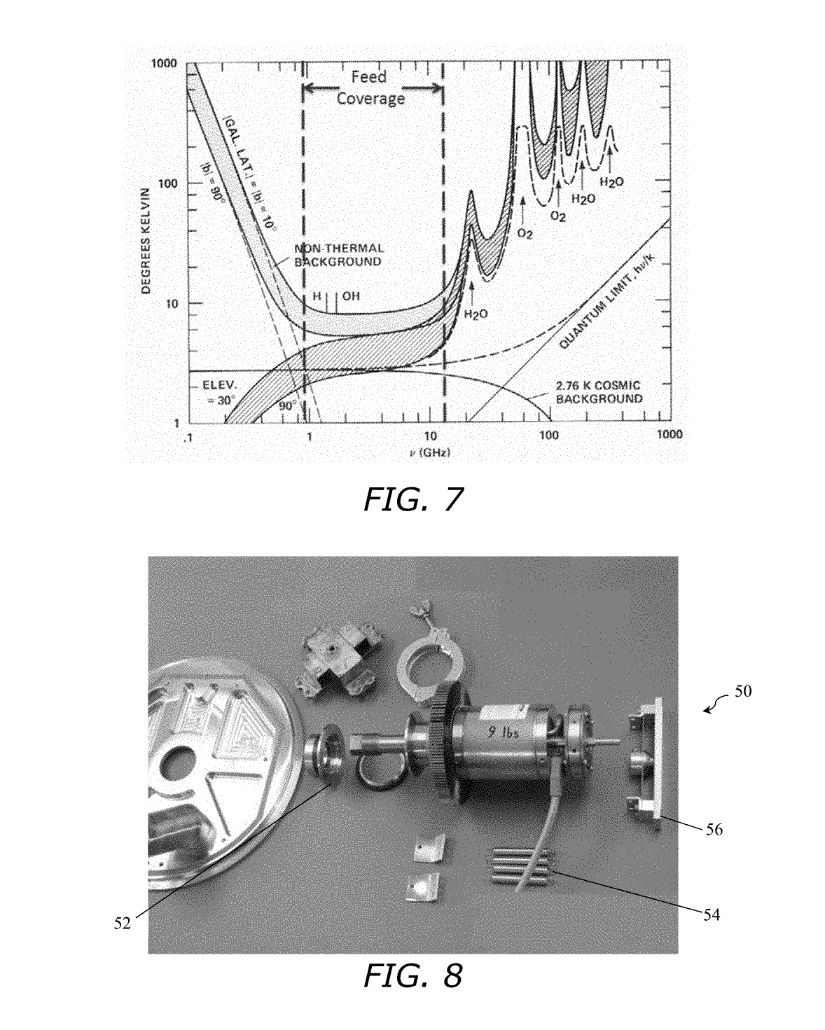

In yet another embodiment, the antenna feed 16 uses a cryo pump 42 (FIG. 2) to cool the feed within the vacuum enclosure. The cryo pump 42 is attached to the proximal end of the feed 16 in order to further reduce to the temperature of the feed to below 65 K to provide a low system temperature for the antenna. It should be understood that the cryo pump is a part of a system with a vacuum chamber. The present antenna feed has the following performance characteristics, which are shown in FIGS. 5-7.

According to another embodiment, the present antenna feeds include a vibration isolation mechanism 50, as shown in FIG. 8. The vibration isolation mechanism 50 isolates the feed 16 from destructive vibrations that may be created by the cryo pump and vacuum system. As shown, the vibration isolation mechanism 50 include bellows 52, a spring system 54 to oppose atmosphere pressure and a tail support hardware 56.

The above example embodiments have been described hereinabove to illustrate various embodiments of a cooled antenna feed for a telescope array. Various modifications and departures from the disclosed example embodiments will occur to those having ordinary skill in the art.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. An offset Gregorian antenna, comprising:
a primary reflector having a substantially paraboloidal shape;
a secondary reflector having substantially an ellipsoidal shape, displaced from the optical axis of the primary reflector;
a feed located substantially coincident with the second focus of the secondary reflector;
a cryo pump to cool the feed; and
a shroud partially surrounding the feed.

2. The antenna of claim 1, wherein the first focus of said secondary reflector is substantially coincident with the focus of the primary reflector

3. The antenna of claim 1, wherein the shroud is located between the feed and a ground while providing substantially unimpeded passage of radiation between the feed and the primary reflector and the secondary reflector.

4. The antenna of claim 1, wherein the primary reflector has a diameter of about 6 meters.

5. The antenna of claim 1, wherein the secondary reflector has a diameter of about 2 meters.

6. The antenna of claim 1, further comprising an enclosure surrounding the feed.

7. The antenna of claim 6, wherein the enclosure is vacuumed sealed.

8. The antenna of claim 6, further comprising a polyethylene anti-reflective material covers a portion of the enclosure.

9. The antenna of claim 6, wherein the enclosure is made of borosilicate glass.

10. The antenna of claim 6, wherein the enclosure is made of fused quartz.

11. The antenna of claim 6, wherein the enclosure is made of composite materials.

12. The antenna of claim 1, wherein the feed includes a low noise amplifier.

13. The antenna of claim 12, wherein the low noise amplifier includes a chassis, an input coax cable connected to one end of the chassis and an output coax cable connected to an opposite end of the chassis.

14. The antenna of claim 13, wherein the resistance of the input coax cable is about 95 ohm.

15. The antenna of claim 13, wherein the resistance of the output coax cable is about 50 ohm.

16. The antenna of claim 12, wherein the low noise amplifier is disposed at a tip of the feed.

17. The antenna of claim 1, wherein the feed includes a thin rexolite standoff

18. The antenna of claim 1, further comprising a vibration isolation mechanism connected to the feed to dampen vibrations.

19. An offset Gregorian antenna, comprising:
a primary reflector having a substantially paraboloidal shape;
a secondary reflector having substantially an ellipsoidal shape, displaced from the optical axis of the primary reflector;
a feed located substantially coincident with the second focus of the secondary reflector;
a vacuum sealed enclosure surrounding the feed; and
a cryo pump in communication with the vacuum sealed enclosure to cool the feed within the vacuum sealed enclosure.

20. The antenna of claim 19, wherein the cryo pump cools the feed within the vacuum sealed enclosure to less than 65 K.
